(19) United States
(12) Patent Application Publication
(10) Pub. No.: US 2005/0108488 A1
(43) Pub. Date: May 19, 2005

(54) Programme-controlled unit

(76) Inventors: Peter Rohm, Pfaffenhofen (DE); Angela Rohm, Pfaffenhofen (DE)

Correspondence Address: BEVER HOFFMAN & HARMS, LLP;TRI-VALLEY OFFICE, 1432 CONCANNON BLVD., BLDG. G, LIVERMORE, CA, 94550, US

(21) Appl. No.: 10/490,230

(22) PCT Filed: Aug. 30, 2002
(86) PCT No.: PCT/DE02/03202

(30) Foreign Application Priority Data
Sep. 21, 2001 (DE) 101 46 516.5

(51) Int. Cl. G06F 12/14

(52) U.S. Cl. 711/163

(57) ABSTRACT

When access to proprietary data or sensitive information stored in a memory device of a programmable unit is attempted, a check is carried out to determine whether the requested access has been or could have been initiated by someone who is not authorized to do so, and in that the memory device outputs requested data, and/or stores data which is supplied to it only when the check shows that it can be assumed that the relevant access has not been initiated or could not have been initiated by someone who is not authorized to do so. Access is controlled, for example, by identifying the source of the requested access, or by associating the requested access with the execution of a secure command.

### FIELD OF THE INVENTION

The present invention relates to a programmable unit with a memory device which can be accessed for reading or writing by various other components in the programmable unit.

### BACKGROUND OF THE INVENTION

A programmable unit such as this may be, for example, a microcontroller, a microprocessor, a signal processor or the like.

There is also a need to protect data which is stored in a programmable unit, to be more precise the data which is stored in a memory device in the programmable unit, against unauthorized access, that is to say to ensure in particular that the data which is stored in the memory device cannot be read and/or edited by unauthorized persons. There are two reasons for this. The first reason is that the stored data frequently represents a considerable proportion of the development of the system which contains the programmable units and thus, as far as possible, should not be come into the hands of competitors. This is the case, for example, with microcontrollers which are used in motor vehicle controllers. Significant engine characteristic data, which stipulates how the engine can be controlled in which situations, is stored in microcontrollers such as these. If competitors gain knowledge of such data, they can gain new knowledge from this for their own products, thus resulting in a development advance which might have been made being lost. The second reason for protection of the memory device is that unauthorized persons should be prevented from changing the engine control system by manipulation of the data in order in this way to increase the performance, the maximum speed, etc. Such manipulation of the engine control system may lead to a reduction in the engine life expectancy or to other damage occurring which would normally not occur, or would not occur until later. This detracts from the reputation of the motor vehicle manufacturer and can also lead to the manufacturer having to satisfy guarantee claims for which he is not responsible.

### SUMMARY OF THE INVENTION

The present invention is therefore directed to a programmable unit including a memory device in which unauthorized persons cannot read and/or edit data which is stored in the memory device.

The programmable unit according to the invention is distinguished in that when the memory device is accessed, a check is carried out to determine whether the respective access has been or could have been initiated by someone who is not authorized to do so, and in that the memory device outputs requested data, and/or stores data which is supplied to it only when the check shows that it can be assumed that the relevant access has not been initiated or could not have been initiated by someone who is not authorized to do so.

This makes it possible to reliably prevent the possibility of the content of the memory device from being read and/or edited by persons who are not authorized to do so.

Advantageous developments of the invention can be found in the dependent claims, in the following description and in the figures.

### BRIEF DESCRIPTION OF THE FIGURES

The invention will be explained in more detail in the following text using exemplary embodiments and with reference to the figure.

FIG. 1 shows the block diagram of a microcontroller in which the memory protection system as described in the following text is implemented.

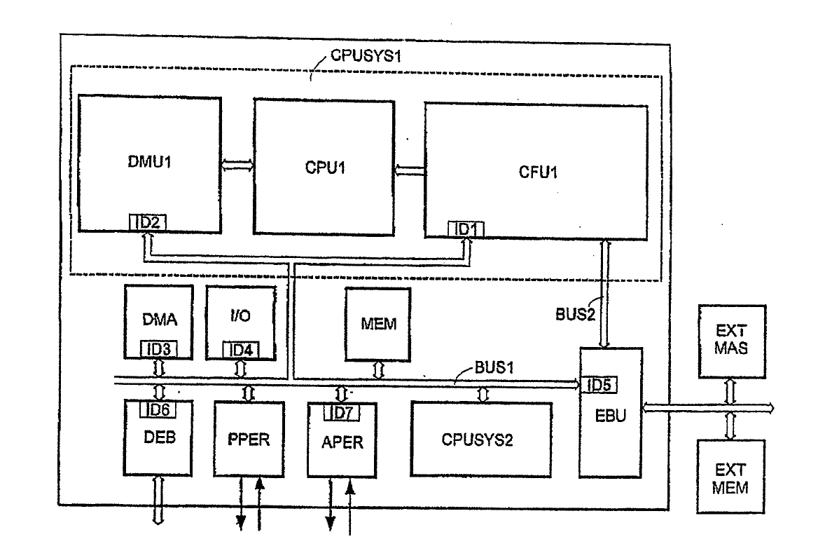

### DESCRIPTION OF A PREFERRED EXEMPLARY EMBODIMENT

Although the described memory protection system is described here with reference to a microcontroller, it may also be used in other programmable units, such as microprocessors and signal processors.

The microcontroller shown in the figure contains:
a first CPU subsystem CPUSYS1,
a second CPU subsystem CPUSYS2,
a DMA controller DMA,
an I/O controller I/O,
an interface EBU to an external bus EXTBUS which is provided outside the microcontroller,
debug resources DEB which are formed, for example, by an OCDS module (on-chip debug support module),
one or more other active peripheral units APER, that is to say peripheral units which may be a bus master, and/or passive peripheral units PPER, that is to say peripheral units which cannot be a bus master,
a common memory device MEM,
a first bus BUS1 which connects the said components to one another, and
a second bus BUS2 which connects the first CPU subsystem CPUSYS1 and the interface EBU to one another.

The first CPU subsystem CPUSYS1 contains a CPU CPU1, a command fetch unit CFU1 and a data memory access unit DMU1.

The second CPU subsystem CPUSYS2 may, but need not have, the same configuration.

An external master unit EXTMAS and an external memory device EXTMEM are connected to the external bus EXTBUS.

For the sake of completeness, it should be mentioned that the microcontroller may also contain a greater number of components or a smaller number of components, and/or other components. In the same way, a greater number of components, a smaller number of components and/or different components may also be connected to the external bus EXTBUS.

The common internal memory device MEM and the manner in which accesses to it are handled are of particular interest in this case. In the example under consideration, this common memory device MEM is the memory to be protected by the described memory protection system, that is to say a memory whose content should not be read and/or edited by persons who are not authorized to do so.

The memory device MEM is connected to the bus BUS1, so that all of the other components which are likewise connected to the bus BUS1 and may be the bus master for the bus BUS1 can access the memory device MEM.

The components which may be the bus master are, in the example under consideration, the first CPU subsystem CPUSYS1, to be more precise the command fetch unit CFU1 and the data memory access unit DMU1 for it, the corresponding components in the second CPU subsystem CPUSYS2, the DMA controller DMA, the I/O controller I/O, the interface EBU, the debug resources DEB and the active peripheral unit or units.

In the example under consideration, the common memory device MEM is a flash memory. However, it could also be any other non-volatile or volatile memory.

The common memory device MEM contains a program memory and a data memory, with the program memory being used to store data which represents commands, and with the data memory being used to store other data, for example operands. The program memory and the data memory are each connected to the other components of the microcontroller via their own address, data and control lines. The address, data and control lines are a component of the bus BUS1.

The microcontroller under consideration accordingly has so-called Harvard architecture, but apart from this operates on the Von-Neumann principle, that is to say it sequentially executes the commands to be executed by it.

At this point, it should actually be mentioned that the described memory protection system can also be used for programmable units which do not have a separate program memory and a data memory.

Only the first CPU subsystem CPUSYS1 of the CPU subsystems CPUSYS1 and CPUSYS2 is considered in the following statements. However, the explanation relating to the first CPU subsystem CPUSYS1 applies in a corresponding manner to the second CPU subsystem CPUSYS2, and the first CPU subsystem CPUSYS1 and the second CPU subsystem CPUSYS2 operate in parallel, or at least may operate in parallel.

During operation of the microcontroller, the first CPU subsystem CPUSYS1 fetches data which represents commands, and the associated operands, from the common memory MEM or from some other memory, and executes them. To be more precise,
the command fetch unit CFU1 in the CPU subsystem CPUSYS1 fetches data which represents commands from the program memory part of the common memory device MEM,
the data memory access unit DMU1 in the CPU subsystem CPUSYS1 fetches data which represents operands as required from the data memory part of the common memory device MEM, and
the CPU CPU1 in the CPU subsystem CPUSYS1 executes the commands in which case, if the execution of a command comprises the transfer of data from and/or to a system component which is provided within or outside the microcontroller, this data transfer is likewise carried out by means of the data memory access unit DMU1.

Thus, in the example under consideration, no data transfer to the common memory device MEM takes place during normal operation. Events etc to be stored are written to a different memory, for example to a microcontroller internal RAM (not shown in the figure) or to the external memory EXTMEM.

To the extent that any write access can be made at all to the common memory device MEM, this is done only at specific operating modes of the microcontroller and subject to security precautions which make it possible to ensure that writing to the common memory device MEM cannot be initiated by persons who are not authorized to do so. By way of example, in this context, it is possible to provide for the capability to edit the content of the common memory device MEM to be possible only via the execution of a bootstrap loader which is stored in the common memory device MEM, in which case this bootstrap loader can be executed exclusively by means of a procedure which is known only to certain persons, and/or in which case the bootstrap loader reprograms the common memory device MEM only once a code which is known only to specific persons has been entered in the microcontroller.

The common memory device MEM furthermore has the special feature that, in the event of accesses to it, it checks whether the respective access could have been initiated by someone who is not authorized to do so, and that the common memory device MEM outputs requested data only when the check shows that the relevant access has not been or could not have been initiated by someone who is not authorized to do so.

Although this is not practiced in the example under consideration, this protection mechanism could also be applied to write accesses to allow the common memory device MEM to be written to during normal operation of the microcontroller. Writing to the common memory device MEM could be allowed provided that care is taken to ensure that the common memory device MEM stores data which is supplied to it only when it can be assumed that the relevant access has not been or could not have been initiated by someone who is not authorized to do so.

In the example under consideration, the check as to whether any given access to the common memory device MEM has been or could have been initiated by someone who is not authorized to do so is carried out by a control device which is a component of the common memory device MEM. However, the control device could also be a device which is connected upstream of the memory device and which passes on to the common memory device accesses made to the memory device MEM only when it can be assumed that the relevant access has not been or could not have been initiated by someone who is not authorized to do so.

In the example under consideration, it is assumed that an access to the common memory device MEM has not been initiated by someone who is not authorized to do so provided that the access
is made by the command fetch unit CFU1, or
is made by the data memory access unit DMU1 and the relevant access is related to the execution of a command which has originated from a memory within the microcontroller whose content cannot be edited or can be edited only by someone who is authorized to read and/or edit the content of the common memory device MEM.

In the example under consideration, the microcontroller contains “only” a single memory, whose content cannot be edited or at most can edited by persons who are authorized to do so, and this is the common memory device MEM. As will be understood even better later, there are, however, no difficulties whatsoever in designing the common memory device MEM such that it outputs requested data and/or stores data which is supplied to it only when it can be assumed that the relevant access to the common memory device MEM is related to the execution of a command which has originated from the common memory device MEM itself or from some other memory whose content cannot be edited, or at most can be edited by specially authorized persons.

If, as in the example under consideration, the common memory device MEM is subdivided into a program memory and a data memory, a check is preferably carried out to determine whether accesses to the program memory originate from the command fetch unit CFU1, and accesses to the data memory originate from the data memory access unit DMU1.

In the example under consideration, the check of the component of the microcontroller from which the respective access to the common memory device originates is carried out on the basis of data which is transmitted via an ID bus which is included in the first bus BUS1. The ID bus is used to transmit so-called identifiers, from it is possible to determine which of the units connected to the first bus BUS1 initiated that particular bus cycle. To be more precise, each of the units which are connected to the first bus BUS1 and which may be the bus master are allocated a specific identifier, which they output when outputting data, data requests or other information or control signals to the ID bus. In the example under consideration, this is done in such a way that:
the command fetch unit CFU1 passes the identifier value 1 to the ID bus,
the data memory access unit DMU1 passes the identifier value 2 to the ID bus,
the DMA controller DMA passes the identifier value 3 to the ID bus,
the I/O controller I/O passes the identifier value 4 to the ID bus,
the interface EBU passes the identifier value 5 to the ID bus, and
the debug resources DEB pass the identifier value 6 to the ID bus, and
the active peripheral unit APER passes the identifier value 7 to the ID bus.

For this purpose, the command fetch unit CFU1, the data memory access unit DMU1, the DMA controller DMA, the I/O controller I/O, the interface EBU, the debug resources DEB and the active peripheral unit APER contain identifier production devices ID1 to ID7 which pass said identifiers to the ID bus.

The identifiers which are output from the respective units to the ID bus are either permanently set or, if they are variable, can be varied only by persons who are authorized to do so.

By evaluation of the data which is transmitted via the ID bus, the control device is able to determine the unit from which an access to the common memory device MEM has originated. All it has to do for this purpose is to check the value which is transmitted together with the read or write request on the ID bus.

If the value 1 is transmitted together with a read or write request to the common memory device on the ID bus, the control device identifies from this that the relevant access has originated from the command fetch unit CFU1. In this situation, there is no risk of someone who is not authorized to do so outputting from the programmable unit or editing data which is stored in the common memory device MEM, so that this access can be allowed. It will be even more secure if the access were allowed only if the access were a read access to the program memory originating from the command fetch unit CFU1.

If the value 2 is transmitted together with a read or write request to the common memory device MEM on the ID bus, the control device uses this to identify that the relevant access has originated from the data memory access unit DMU1. In this case, the control device must also check whether the relevant access is or could be related to the execution of a command which has originated from a memory whose content can be edited only by someone who is authorized to read the content of the common memory device MEM1. If this additional condition is satisfied, there is no risk of someone who is not authorized to do so outputting from the programmable unit or editing data which is stored in the common memory device MEM, so that this access can be allowed. Otherwise, the access to the common memory device MEM must be refused. The way in which the check of the additional condition is carried out will be explained in more detail later.

If the value 3, 4, 5, 6 or 7 is transmitted together with a read or write request to the common memory device on the ID bus, the control device uses this to identify that the relevant access has originated from the DMA controller DMA, from the I/O controller I/O, from the interface EBU, from the debug resources DEB, or from the active peripheral unit APER. In this case, there is a risk of someone who is not authorized to do so outputting from the programmable unit or editing data which is stored in the common memory device, so that this access is not allowed. In certain situations, to be more precise when it is or was not possible for someone who is not authorized to do so to cause the unit requesting the access to initiate this access, this access could also be allowed. A situation such as this may arise, for example, when the commands which are executed by the microcontroller are exclusively commands which are stored in the common memory device, and the DMA controller DMA, the I/O controller I/O, the interface EBU, the debug resources DEB and the active peripheral unit APER can be configured or can be caused to carry out specific actions only by particularly authorized persons or by commands which are executed by the microcontroller.

The check of the component of the microcontroller from which access to the common memory device MEM has originated may also be carried out in a different manner.

One of the possible alternatives is for at least the command fetch unit CFU1 and the data memory access unit DMU1, but possibly also in addition one, two or more or all of the other components which may access the common memory device, to be connected to the common memory device MEM or to the control device via separate lines which are not shown in the figure, and for said components to signal via said lines whether they are currently accessing the common memory device MEM via the bus BUS1. In this situation as well, the common memory device MEM or the control device can unambiguously determine the component from which any particular access to the common memory device MEM has originated.

A further alternative is for the component which is requesting access to the common memory device MEM to identify itself to the common memory device or to the control device as the sender of the read or write request by the transmission of appropriate data via the data bus and/or the address bus. However, in this case, it would be necessary to ensure that the identification data output by the respective components cannot be set or varied, or can be set or varied only by specific persons.

First of all, the expressions “protected memory” and “unprotected memory” as used a number of times in this case will be defined before the execution of the additional check, as already mentioned above, is described in the following text, which check is used to determine whether an access to the common memory device MEM is related to the execution of a command which has originated from a memory whose content cannot be edited or at most can be edited by someone who is authorized to do so.

A “protected memory” is a memory which is provided within the microcontroller and whose content cannot be edited or at least cannot be edited by someone who is not authorized to read and/or edit the content of the common memory MEM.

An “unprotected memory” is a memory whose content can be edited by someone who is not authorized to read and/or edit the common memory MEM. One such memory, for example, is the external memory EXTMEM or an unprotected memory within the microcontroller.

The additional check mentioned above as to whether an access to the common memory device MEM is related to the execution of a command which has originated from an unprotected memory is carried out in the example under consideration by the common memory device MEM or the control device tracking the addresses, data and/or control signals which are transmitted via the bus BUS1 in order to monitor whether the command fetch unit CFU1 has previously loaded commands from an unprotected memory.

If this is not the case, that is to say if the command fetch unit CFU1 has not fetched any command from an unprotected memory since the microcontroller was started up, the situation is clear: the access to the common memory device MEM cannot be related to the execution of a command which has originated from an unprotected memory, so that there is no risk of the data which is stored in the common memory device MEM being read from the microcontroller or being edited by someone who is not authorized to do so. In consequence, the access to the common memory device can be allowed.

Otherwise, to be more precise if the command fetch unit CFU1 has fetched one or more commands from an unprotected memory at any time before the access to the common memory device MEM, there is a risk of the data which is stored in the common memory device MEM being read from the microcontroller or being edited by someone who is not authorized to do so. Whether this is actually the situation depends on the specific circumstances, to be precise inter alia on
whether there is a command processing pipeline,
how many stages the pipeline has,
whether there is an instruction queue,
how long any instruction queue which may exist is,
whether the command fetch unit CFU1 has an instruction cache, and
how long it is since the last command was fetched from the unprotected memory.

If it is certain that no commands which have previously been fetched from an unprotected memory are located either in the pipeline, in the instruction queue, in the instruction cache or in any other memory device in the CPU subsystem CPUSYS1, the access to the common memory device MEM may be allowed.

If it is impossible to be certain that no commands which have previously been fetched from an unprotected memory are located in the pipeline, in the instruction queue, in the instruction cache or in any other memory device in the CPU subsystem CPUSYS1, access to the common memory device MEM must not be allowed.

The check as to whether an access to the common memory device MEM is related to the execution of a command which has originated from an unprotected memory may also be carried out in a different way.

One possible alternative is for the command fetch unit CFU1 to be connected to the common memory device MEM via a separate line, which is not shown in the figure, and for the command fetch unit CFU1 to signal to the common memory device MEM via this separate line whether any commands which have previously been fetched from an unprotected memory are or may still be stored in the pipeline, in the instruction queue, in the instruction cache or in some other memory device in the CPU subsystem CPUSYS1.

It would also be possible to provide for the programmer of the program to be executed by the microcontroller to have to ensure by means of appropriate programming that there is no doubt as to whether access to the common memory MEM is related to the execution of a command which has originated from an unprotected memory. This may be achieved, for example,
in that, when the intention is once again to execute commands which have originated from the common memory device MEM or from some other protected memory after execution of commands which have originated from an unprotected memory, a certain number of neutral commands such as NOP commands are first of all executed, with the number of these commands being designed to be sufficiently great that it is possible to assume with confidence after they have been executed that no more commands which have originated from an unprotected memory are stored or may be stored in the pipeline, in the instruction queue, in the instruction cache or in some other memory device in the CPU subsystem CPUSYS1 which require access to the common memory device MEM, and
in that when it is intended to execute commands which have originated from an unprotected memory after execution of commands which have originated from the common memory device MEM or from some other protected memory, a certain number of neutral commands such as NOP commands are first of all executed, with the number of these commands being designed to be sufficiently great that it is possible to assume with confidence after they have been executed that no more commands which have originated from a protected memory are stored or may be stored in the pipeline, in the instruction queue, in the instruction cache or in some other memory device in the CPU subsystem CPUSYS1 which require access to the common memory device MEM.

In this way, the programmer can prevent those commands which have originated from a protected memory and commands which have originated from an unprotected memory and which require access to the common memory device MEM being located in the pipeline, in the instruction queue, in the instruction cache or in some other memory device in the CPU subsystem CPUSYS1. This means that it is possible to determine simply and reliably whether an access from the data memory access unit DMU1 to the common memory device MEM is related to the execution of a command which has originated from a protected memory or is related to the execution of a command which has originated from an unprotected memory.

For the sake of completeness, it should be noted that the debug resources DEB are preferably able to deactivate the mechanism as described above for protection of the common memory device MEM, although deactivation should not be possible unless the person who is initiating the deactivation has verified his authorization to do so, for example by inputting a secret code word.

The described programmable unit makes it possible, irrespective of the details of the practical implementation, to preclude in all circumstances the content of a memory device to be protected being read and/or edited by someone who is not authorized to do so.

List of Reference Symbols

APER Active peripheral units, that is to say peripheral units which may be a bus master
BUS1 Bus which connects the components of the microcontroller to one another
BUS2 Bus which connects CPUSYS1 and EBU
CFU1 Command fetch unit for CPUSYS1
CPU1 CPU for CPUSYS1
CPUSYS1 First CPU subsystem
CPUSYS2 Second CPU subsystem
DEB Debug resources
DMA DMA controller
DMU1 Data memory access unit for CPUSYS1
EBU Interface to the external bus
EXTBUS External bus
EXTMAS Unit which is connected to EXTBUS and may be a master
EXTMEM External memory device which is connected to EXTBUS
I/O I/O controller
MEM Common memory device
PPER Passive peripheral units, that is to say peripheral units which cannot be a bus master

1. A programmable unit having a memory device (MEM) which can be accessed for reading or writing by various other components (CFU1, DMU1, CPUSYS2, DMA, I/O, EBU, DEB, APER) of the programmable unit, characterized
in that, when the memory device (MEM) is accessed, a check is carried out to determine whether the respective access has been or could have been initiated by someone who is not authorized to do so,
with this check comprising checking the component (CFU1, DMU1, CPUSYS2, DMA, I/O, EBU, DEB, APER) of the programmable unit from which the access to the memory device (MEM) has originated, and
with the decision being made as a function of the component of the programmable unit from which the access to the memory device has originated as to whether it can be assumed that the relevant access was or could have been initiated by someone who is not authorized to do so, and
in that the memory device (MEM) outputs requested data, and/or stores data which is supplied to it only when the check shows that it can be assumed that the relevant access has not been initiated or could not have been initiated by someone who is not authorized to do so.

2. The programmable unit as claimed in claim 1, characterized in that the memory device (MEM) outputs requested data when the request originates from a command fetch unit (CFU1) which fetches the commands to be carried out by the programmable unit and supplies them to a CPU (CPU1), which carries out the commands, in the programmable unit.

3. The programmable unit as claimed in claim 1, characterized in that accesses to the memory device (MEM) which do not originate from the command fetch unit (CFU1) which fetches the commands to be carried out by the programmable unit and supplies them to a CPU (CPU1), which carries out the commands, in the programmable unit, are not actioned, or are actioned only in specific circumstances.

4. The programmable unit as claimed in claim 1, characterized in that the memory device (MEM) does not output requested data and/or does not store data supplied to it if the related access is or could be related to the execution of a command which has originated from a memory (EXTMEM) whose content can be edited by someone who is not authorized to read and/or edit the content of the memory device (MEM).

5. The programmable unit as claimed in claim 1, characterized in that an access to the memory device (MEM) which has originated from a data memory access unit (DMU1) by means of which data is fetched or output which is required for command execution or whose transfer is one of the operations associated with command execution is actioned only if the relevant access is not related or could not be related to the execution of a command which has originated from a memory (EXTMEM) whose content can be edited by someone who is not authorized to read and/or edit the content of the memory device (MEM).

6. The programmable unit as claimed in claim 1, characterized in that the check to determine the component (CFU1, DMU1, CPUSYS2, DMA, I/O, EBU, DEB, APER) in the programmable unit from which the access to the memory device (MEM) originates is carried out by evaluation of an identifier which the component that originates the access transmits via a portion of the bus (BUS1) which connects the components of the programmable unit to one another.

7. The programmable unit as claimed in claim 1, characterized in that the check to determine the component (CFU1, DMU1, CPUSYS2, DMA, I/O, EBU, DEB, APER) in the programmable unit from which the access to the memory device (MEM) has originated is carried out by evaluation of signals which are transmitted via lines which are reserved for this purpose to the memory device (MEM) from at least some of the components which can access the memory device, and by means of which the relevant components signal whether they are or are not currently accessing the memory device.

8. The programmable unit as claimed in claim 1, characterized in that the check as to whether an access to the memory device (MEM) has been or could have been initiated by someone who is not authorized to do so comprises checking whether the relevant access is or could be related to the execution of a command which has originated from a memory (EXTMEM) whose content can be edited by someone who is not authorized to read and/or edit the content of the memory device (MEM).

9. The programmable unit as claimed in claim 8, characterized in that the check as to whether an access to the memory device (MEM) is or could be related to the execution of a command which has originated from a memory (EXTMEM) whose content can be edited by someone who is not authorized to read and/or edit the content of the memory device comprises the tracking of the addresses, data and/or control signals which are transmitted via a bus (BUS1, BUS2) via which the command fetch unit (CFU1) of the microcontroller fetches the commands to be executed.

10. The programmable unit as claimed in claim 8, characterized in that the check as to whether an access to the memory device (MEM) is or could be related to the execution of a command which has originated from a memory (EXTMEM) whose content can be edited by someone who is not authorized to read and/or edit the content of the memory device (MEM) is carried out by evaluation of a signal which the command fetch unit (CFU1) transmits via a line which is reserved for this purpose to the memory device (MEM) and by means of which the command fetch unit (CFU1) signals whether a command which has already been fetched is located or may be located in an instruction queue, in a command processing pipeline, in an instruction cache or in some other buffer store, with this command which has already been fetched originating from a memory (EXTMEM) whose content can be edited by someone who is not authorized to read and/or edit the content of the memory device (MEM).

11. The programmable unit as claimed in claim 1, characterized in that the check as to whether an access to the memory device (MEM) has been or could have been initiated by someone who is not authorized to do so is carried out by a control device.

12. The programmable unit as claimed in claim 11, characterized in that the control device is a component of the memory device (MEM).

13. The programmable unit as claimed in claim 11, characterized in that the control device is a device which is connected upstream of the memory device (MEM).

14. A programmable unit comprising:
a memory device including protected memory locations storing proprietary data;
a bus coupled to the memory device, the bus including means for transmitting the proprietary data stored in the protected memory locations;
a plurality of components coupled to the bus, each of the components including means for accessing the protected memory locations of the memory device via the bus, wherein the plurality of components include one or more authorized components and one or more non-authorized components;
means for controlling access to the protected memory locations of memory device by the plurality of components, said access controlling means including:
means for identifying an accessing component of the plurality of components from which a requested access to the protected memory locations has originated, and
means for preventing execution of the requested access when the identified accessing component is one of said non-authorized components.

15. The programmable unit according to claim 14,
wherein the programmable unit further comprises a central processing unit (CPU),
wherein the authorized components include a command fetch unit for fetching the commands to be executed by the CPU, and
wherein the means for controlling access comprises means for executing the requested access when the identified accessing component is said command fetch unit.

16. The programmable unit according to claim 14,
wherein the programmable unit further comprises a central processing unit (CPU),
wherein the authorized components include a data memory access unit for fetching data associated with the execution of a command by the CPU, and
wherein the means for controlling access comprises means for executing the requested access when the identified accessing component is said data memory access unit and the requested access is related to the execution of a command which has originated from a memory within the programmable unit whose content cannot be edited without authorization.

17. The programmable unit according to claim 14, wherein said means for identifying the accessing component comprises means for reading an identification code transmitted from the accessing component on the bus.

18. The programmable unit according to claim 14, further comprising reserved lines coupled between at least some of the plurality of components and the memory device, wherein said means for identifying the accessing component comprises means for reading an identification code transmitted from the accessing component on the reserved lines.

19. A programmable unit comprising:
a memory device including protected memory locations storing secure command information and proprietary data;
a bus coupled to the memory device, the bus including means for transmitting the proprietary data stored in the protected memory locations;
a plurality of components coupled to the bus, each of the components including means for accessing the protected memory locations of the memory device via the bus;
means for controlling access to the protected memory locations of memory device by the plurality of components, said access controlling means including means for preventing execution of a requested access to the proprietary data stored in the protected memory locations unless the requested access is generated in response to execution of at least one secure command of said secure command information.

20. The programmable unit according to claim 19,
wherein the programmable unit further comprises a central processing unit (CPU) for sequentially executing commands stored in at least one of an instruction queue, a command processing pipeline, an instruction cache, and a buffer store,
wherein the plurality of components include a command fetch unit for fetching the commands from the memory device for execution by the CPU,
wherein the command fetch unit includes means for transmitting a signal to the memory device when at least one unsecured command has been fetched for execution by the CPU and is present in said at least one of said instruction queue, said command processing pipeline, said instruction cache, and said buffer store, and
wherein the means for controlling access comprises means for preventing execution of the requested access while the signal is concurrently generated by the command fetch unit.
